(19) United States
(12) Patent Application Publication
(10) Pub. No.: US 2025/0062465 A1
(43) Pub. Date: Feb. 20, 2025

(54) DOUBLE-WALLED ENCLOSURE AND/OR COOLING SYSTEM FOR PRISMATIC BATTERY CELLS

(71) Applicant: GM GLOBAL TECHNOLOGY OPERATIONS LLC, Detroit, MI (US)

(72) Inventors: Diptak BHATTACHARYA, Royal Oak, MI (US); Anil K. SACHDEV, Rochester Hills, MI (US); Ryan Patrick HICKEY, Austin, TX (US)

(21) Appl. No.: 18/449,016

(22) Filed: Aug. 14, 2023

(51) Int. Cl. H01M 50/209; H01M 10/04; H01M 10/653; H01M 10/6555; H01M 50/236

(52) U.S. Cl. CPC H01M 50/209; H01M 10/04; H01M 10/653; H01M 10/6555; H01M 50/236

(57) ABSTRACT

A battery cell includes a battery cell stack including A anode electrodes, C cathode electrodes, and S separators, where A, C, and S are integers greater than one. A double-walled prismatic enclosure is configured to house the battery cell stack including a can body including an inner enclosure, an outer enclosure, and a gap between the inner enclosure and the outer enclosure. The battery cell stack is arranged in the inner enclosure. The outer enclosure of the can body defines a first opening and a second opening at opposite ends thereof. A first lid portion is attached to the first opening of the outer enclosure. A first bottom portion is attached to the second opening of the outer enclosure.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a double-walled enclosure and/or a cooling system for prismatic battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery cell includes a battery cell stack including A anode electrodes, C cathode electrodes, and S separators, where A, C, and S are integers greater than one. A double-walled prismatic enclosure is configured to house the battery cell stack including a can body including an inner enclosure, an outer enclosure, and a gap between the inner enclosure and the outer enclosure. The battery cell stack is arranged in the inner enclosure. The outer enclosure of the can body defines a first opening and a second opening at opposite ends thereof. A first lid portion is attached to the first opening of the outer enclosure. A first bottom portion is attached to the second opening of the outer enclosure.

In other features, a first side of the outer enclosure includes a plurality of stiffening portions arranged in a first pattern. A second side of the outer enclosure includes a plurality of stiffening portions arranged in a second pattern. The first pattern and the second pattern are different. The first pattern and the second pattern are offset to allow nesting of the battery cell with one or more adjacent battery cells. The plurality of stiffening portions comprise at least one of dimples and stiffening beads.

In other features, the dimples have one of a rectangular cross section and an arcuate cross section. Thermal interface material is arranged in the gap between the inner enclosure and the outer enclosure. A second lid portion encloses a third opening of the inner enclosure. A second bottom portion encloses a fourth opening of the inner enclosure.

In other features, at least one of the first lid portion and the first bottom portion includes a vent.

A system comprises a plurality of the battery cells and a cooling plate. A thermal interface material is arranged between the cooling plate and a first one of the plurality of the battery cells and a second one of the plurality of the battery cells.

A method for manufacturing a double-walled prismatic battery cell includes folding a sheet of metal to form an inner enclosure of the double-walled prismatic battery cell; and folding the sheet of metal to form an outer enclosure of the double-walled prismatic battery cell around the inner enclosure with an air gap arranged between the outer enclosure and the inner enclosure. The outer enclosure includes a first opening and a second opening. The method includes arranging a battery cell stack in the inner enclosure; attaching a first lid portion to a first opening of the outer enclosure; and attaching a first bottom portion to a second opening of the outer enclosure.

In other features, the battery cell stack includes A anode electrodes, C cathode electrodes, and S separators, where A, C, and S are integers greater than one.

In other features, the method includes using first and second rollers to create a first pattern of stiffening portions on a first side of the outer enclosure and a second pattern of stiffening portions on a second side of the outer enclosure. The first pattern of stiffening portions and the second pattern of stiffening portions are different. The first pattern of stiffening portions and the second pattern of stiffening portions are offset to allow nesting of the double-walled prismatic battery cell with one or more adjacent double-walled prismatic battery cells. The first pattern of stiffening portions comprise dimples having at least one of a rectangular cross section and an arcuate cross section. The first pattern of stiffening portions comprise stiffening beads.

In other features, the method includes arranging thermal interface material in the gap.

In other features, the method includes, prior to attaching the first lid portion, enclosing a third opening of the inner enclosure using a second lid portion. In other features, the method includes, prior to attaching the first bottom portion, enclosing a fourth opening of the inner enclosure using a second bottom portion.

In other features, the method include providing a vent on at least one of the first lid portion and the first bottom portion.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes, and separators arranged in a battery cell enclosure according to the present disclosure;

FIG. 2A is a perspective view of an example of a prismatic battery cell;

FIG. 2B is a perspective view of an example of a prismatic battery cell with a pressure-based vent cap;

FIG. 3A is a perspective view of an example of a plurality of prismatic battery cells with a thermal barrier material arranged therebetween;

FIG. 3B is a perspective view of an example of a plurality of double-walled prismatic battery cells without a thermal barrier material arranged therebetween according to the present disclosure;

FIG. 3C is a graphs illustrating thermal conductivity as a function of temperature for air and aerogel;

FIGS. 4A to 4F are perspective views of examples of double-walled prismatic battery cells with stiffening portions according to the present disclosure;

FIGS. 5A and 5B are side views illustrating examples of stiffening portions on adjacent double-walled prismatic battery cells according to the present disclosure;

FIG. 5C is a side view illustrating an example of side walls in locations without stiffening portions according to the present disclosure;

FIG. 5D is a side view illustrating an example of side walls with thermal interface material according to the present disclosure;

FIG. 6A is a perspective view illustrating an example of manufacturing of the double-walled prismatic battery cell according to the present disclosure;

FIG. 6B is a plan view illustrating an example of manufacturing of the double-walled prismatic battery cell according to the present disclosure;

FIGS. 7A to 7C are perspective views illustrating an example of manufacturing of the double-walled prismatic battery cell during folding according to the present disclosure;

FIGS. 8A and 8B are exploded perspective views of examples of double-walled prismatic battery cells according to the present disclosure;

FIGS. 9 and 10 are perspective views of examples of a plurality of double-walled prismatic battery cells arranged on a thermal interface material and a cooling plate according to the present disclosure;

FIGS. 11 and 12 illustrate examples of an interface between the thermal interface material and the cooling plate according to the present disclosure; and

FIGS. 13 and 14 are perspective views of examples of a plurality of double-walled prismatic battery cells and a thermal interface material and a cooling plate according to the present disclosure.

In the drawings, reference numbers may be reused to identify similar and/or identical elements.

### DETAILED DESCRIPTION

While double-walled prismatic battery cells according to the present disclosure are shown in the context of electric vehicles, the double-walled prismatic battery cells can be used in stationary applications and/or other applications.

Aerogels have been used as a thermal barrier material to prevent thermal runaway propagation between adjacent battery cells. The present disclosure relates to prismatic battery cells including a double-walled prismatic enclosure with an insulating layer of air between the inner and outer walls of the enclosure. At elevated temperatures, air has lower thermal conductivity than aerogels.

The air gap acts as a “virtual” thermal barrier material to retard heat transfer from the inner wall to the outer wall to reduce or prevent heat propagation to adjacent battery cells. The inner walls of the double-walled prismatic enclosure present a flat surface in contact with outer surfaces of the battery stack (e.g., jelly roll or cell electrode stack). In some examples, the outer walls are stamped with stiffening beads (or dimples) to increase stiffness and reduce expansion of the enclosure. In some examples, the double-walled prismatic enclosure is formed by a roll forming process followed by welding. One or more lid portions and/or bottom portions enclose the outer enclosure and/or the inner enclosure double-walled prismatic enclosure.

In some examples, the double-walled prismatic enclosure is made using low-cost bending and flanging processes similar to soup cans. The method can be used with large form factor cells. The double walls of the double-walled prismatic enclosure also provide energy absorption.

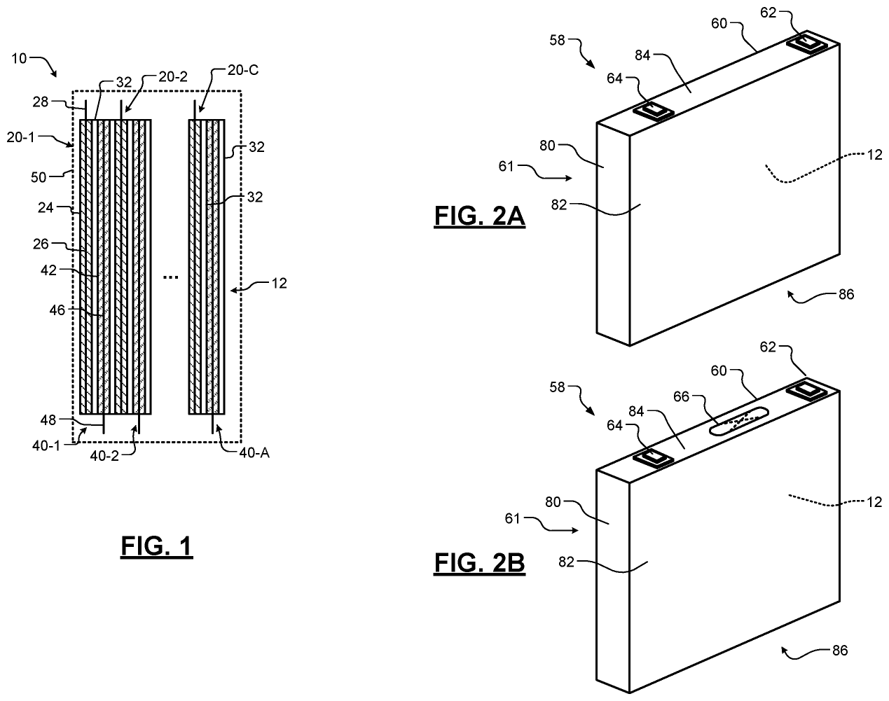

Referring now to FIG. 1, a battery cell 10 includes C cathode electrodes 20, A anode electrodes 40, and S separators 32 arranged in a predetermined sequence in a stack 12 located in an enclosure 50. The C cathode electrodes 20-1, 20-2, . . . , and 20-C (where C is an integer greater than one) include cathode active layers 24 arranged on one or both sides of cathode current collectors 26. The A anode electrodes 40-1, 40-2, . . . , and 40-A (where A is an integer greater than one) include anode active layers 42 arranged on one or both sides of the anode current collectors 46.

In some examples, the anode active layers 42 and/or the cathode active layers 24 are free-standing electrodes that are arranged adjacent to (or attached to) the current collectors. In some examples, the anode active layers 42 and/or the cathode active layers 24 comprise coatings including one or more active materials, one or more conductive fillers/additives, and/or one or more binder materials. In some examples, the battery cells and/or electrodes are manufactured by applying a slurry to coat the current collectors in a roll-to-roll manufacturing process. In some examples, the cathode current collectors 26 and/or the anode current collectors 46 comprise a foil layer. In some examples, the current collectors are made of one or more materials selected from a group consisting of copper, stainless steel, brass, bronze, zinc, aluminum, and alloys thereof.

Referring now to FIGS. 2A and 2B, a prismatic battery cell 58 includes an enclosure 60. The enclosure 60 includes a single wall. In some examples, the enclosure 60 has rectangular cross-sections in x-, y- and z-axis planes. The enclosure 60 includes a can body 61 including sides 80 and sides 82 defining an open-ended rectangular cube.

A lid portion 84 and a bottom portion 86 are attached to the can body 61 to enclose top and the bottom openings of the can body 61, respectively. The prismatic battery cell 58 includes external terminals 62 and 64 that pass through the lid portion 84. The stack 12 of the C cathode electrodes 20, the A anode electrodes 40, and the S separators 32 is arranged in the enclosure 60.

The external terminals 62 and 64 are connected to external tabs of the A anode electrodes 40 and the C cathode electrodes 20, respectively. In FIG. 2A, the lid portion 84 does not include a pressure-based vent cap. In FIG. 2B, the lid portion 84 (and/or the bottom portion 86) includes a pressure-based vent cap 66. The pressure-based vent cap 66 is configured to release vent gases when pressure within the inner enclosure is greater than a predetermined pressure.

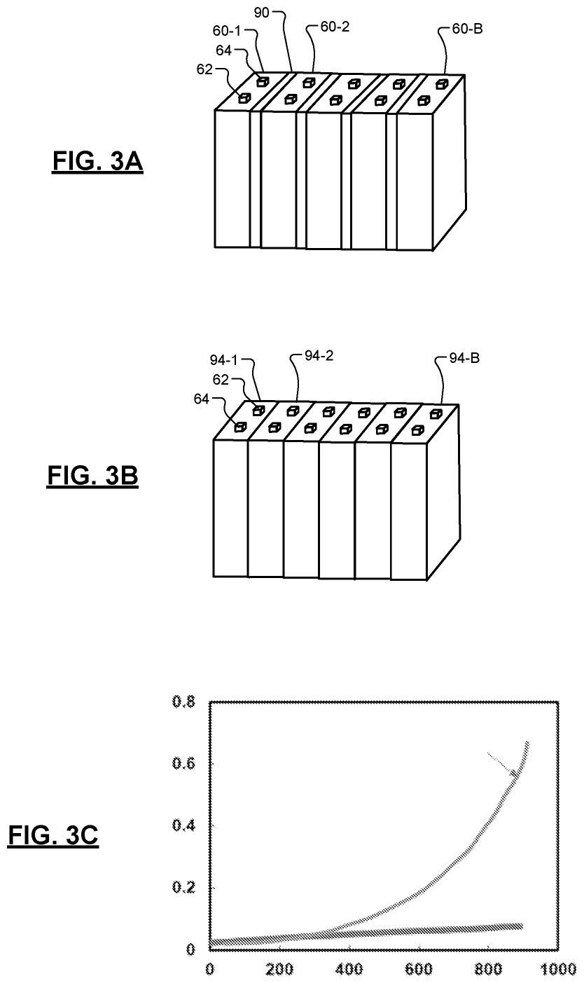

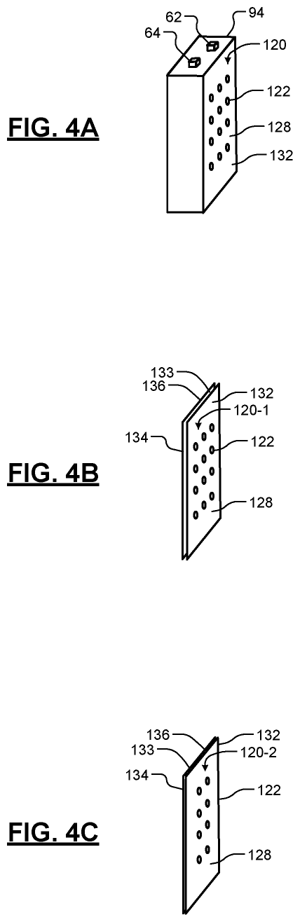

Referring now to FIG. 3A, a plurality of the single-walled prismatic battery cells 60-1, 60-2, . . . , and 60-B (where B is an integer greater than one) are shown. A thermal barrier material 90 is arranged between side surfaces (e.g., sides 82) of adjacent ones of the single-walled prismatic battery cells 60-1, 60-2, . . . , and 60-B. In some examples, the thermal barrier material 90 comprises aerogel or another suitable thermal barrier material. The thermal barrier material 90 is used to reduce the transfer of heat between the plurality of single-walled prismatic battery cells 60-1, 60-2, . . . , and 60-B to reduce thermal runaway propagation (TRP). However, the thermal barrier material is expensive.

In FIG. 3B, double-walled prismatic battery cells 94 according to the present disclosure include an inner enclosure connected to and arranged inside of an outer enclosure. The battery stack is arranged in the inner enclosure. An air gap is located between the inner enclosure and the outer enclosure. The air gap reduces the transfer of heat from one battery cell to adjacent battery cells. In FIG. 3B, a plurality of double-walled prismatic battery cells 94-1, 94-2, . . . , and 94-B are shown without the thermal barrier material arranged therebetween. The air gap of the double-walled prismatic battery cells 94 provides a thermal barrier that inhibits the transfer of heat from one prismatic battery cell to an adjacent battery cell and, as a result, reduces the likelihood of thermal runaway propagation (TRP). In other words, the thermal barrier material can be omitted in some examples, which reduces cost.

Referring now to FIG. 3C, thermal conductivity of aerogel and air is shown as a function of temperature. As temperature increases, the thermal conductivity of the aerogel increases at a much higher rate than air. At higher temperatures where thermal runaway occurs, air is a much better insulator than aerogel. In other words, the aerogel transmits heat faster than air (if one cell heats up, there is increased heating of the adjacent battery cells when using aerogel as compared to air).

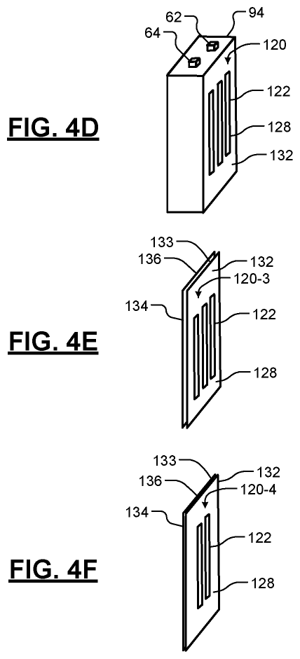

Referring now to FIGS. 4A to 4F, a double-walled prismatic battery cell 94 is shown with a plurality of stiffening portions 122. While the stiffening portions include dimples, the stiffening portions 122 can have different shapes such as beads or other shapes. In some examples, the stiffening portions 122 are arranged in a predetermined pattern 120 on a side surface 128 of an outer enclosure 132 of the double-walled prismatic battery cell 94.

In FIG. 4A, the stiffening portions 122 include dimples that extend outwardly from the side surface 128 of the outer enclosure 132. A side surface 134 of an inner enclosure 136 is arranged adjacent to and spaced from the side surface 128 of the outer enclosure 132 to create an air gap 133 therebetween. The air gap 133 acts as insulation to reduce heat transfer between adjacent double-walled prismatic battery cells. In FIG. 4B, the stiffening portions 122 are arranged in a first predetermined pattern 120-1 on one of the side surfaces 128 of the outer enclosure 132. In FIG. 4C, the stiffening portions 122 are arranged in a second predetermined pattern 120-1 on an opposite one of the side surfaces 128 of the outer enclosure 132.

In FIGS. 4D to 4F, the stiffening portions 122 comprise stiffening ribs that extend vertically or horizontally. The stiffening portions 122 are arranged in a first predetermined pattern 120-3 on one side of the double-walled prismatic battery cell 94 and a second predetermined pattern 120-4 on an opposite side surface of the double-walled prismatic battery cell 94.

In some examples, the first predetermined pattern and the second predetermined pattern are the same. In other examples, the stiffening portions of the first predetermined pattern and the second predetermined pattern are different. For example, the stiffening portions on one side are offset relative to the stiffening portions on the opposite side to allow nesting of the stiffening portions 122 with adjacent prismatic battery cells. In other words, adjacent ones of the double-walled prismatic battery cells can be arranged in close proximity (e.g., with the stiffening portions in a nesting or interleaved pattern when aligned and/or positioned adjacent to one another).

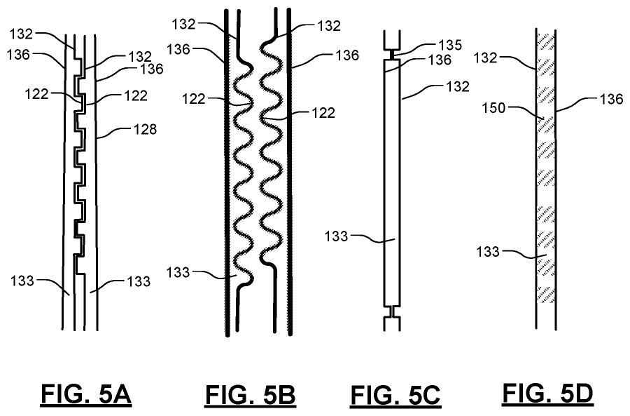

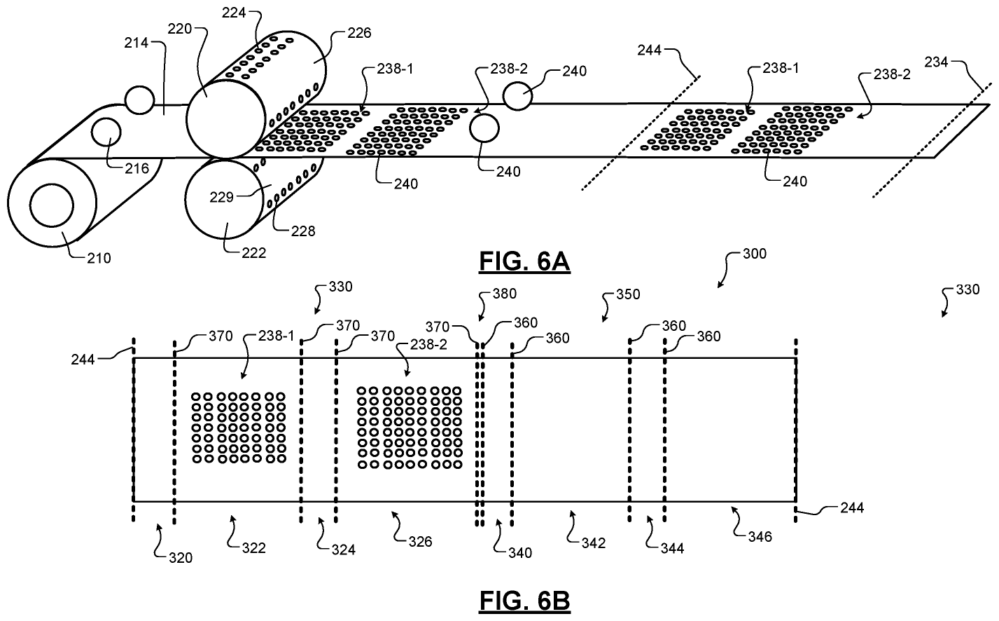

Referring now to FIGS. 5A and 5B, additional examples of the stiffening portions 122 are shown. In FIG. 5A, the stiffening portions 122 are arranged on side surfaces of adjacent double-walled prismatic battery cells and include the first predetermined pattern and the second predetermined pattern that are different to allow nesting. In FIG. 5A, the stiffening portions 122 have a rectangular or polygonal shape. In FIG. 5B, the stiffening portions 122 have an arcuate or semicircular shape.

In FIG. 5C, the side walls of the outer enclosure 132 and the inner enclosure 136, respectively, may include dimples or beads 135 that help to ensure spacing of the air gap 133. In some examples, dimples or beads 135 extend inwardly from one or both of the outer enclosure 132 and the inner enclosure 136 on the sides or ends to maintain the dimensions of the air gap 133 between the side walls of the outer enclosure 132 and the inner enclosure 136, respectively.

In FIG. 5D, the side walls of the outer enclosure 132 and the inner enclosure 136, respectively, are shown with a thermal interface material 150 at spaced locations to improve heat transfer from inside of the double-walled prismatic battery cell 94 to the outer enclosure 132 if cooling is used. The thermal interface material 150 can also be arranged in locations with the stiffening portions and/or continuously fill volume between the side walls of the outer enclosure 132 and the inner enclosure 136, respectively.

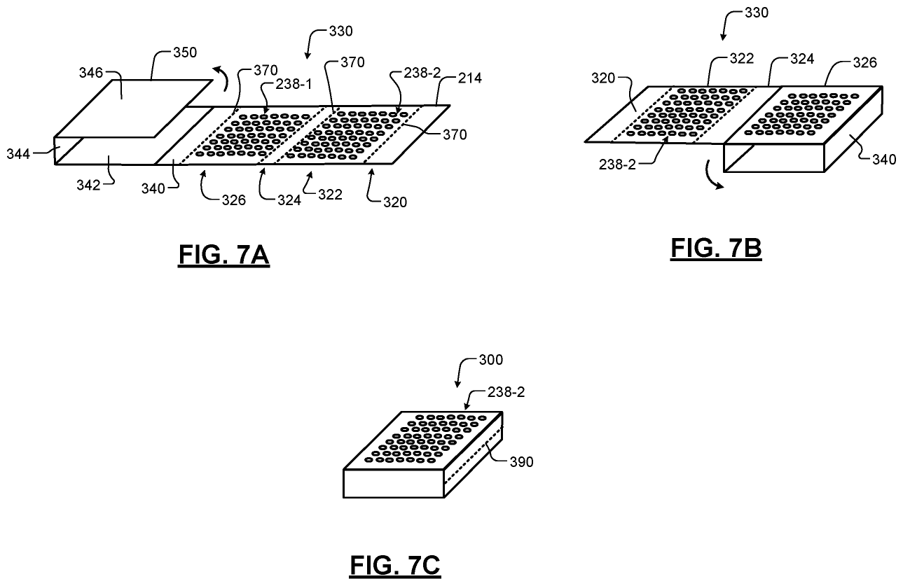

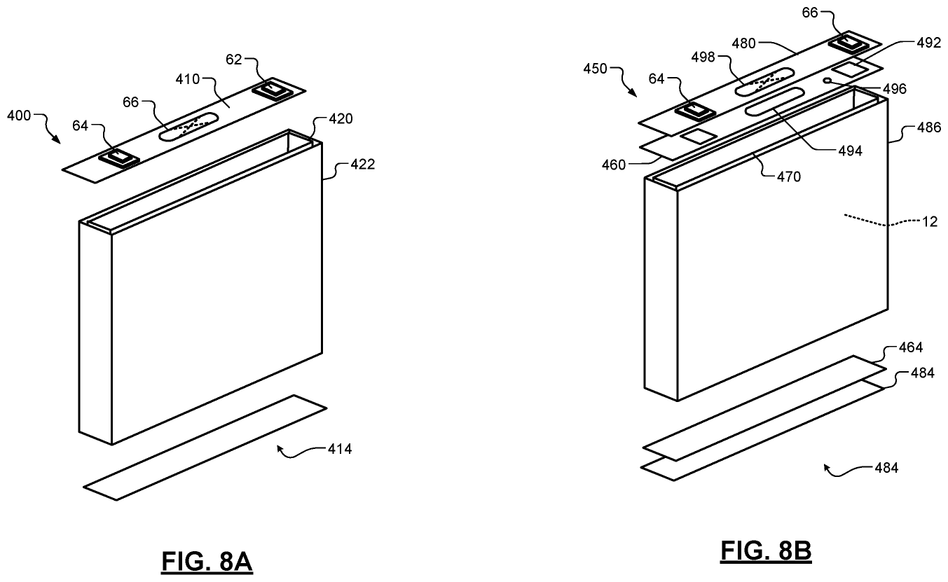

Referring now to FIG. 6A to 7C, manufacturing of the double-walled prismatic battery cell is shown. In FIG. 6A, a metal sheet 214 is optionally trimmed at 216 and then pressed between the first roller 220 and the second roller 222. In some examples, the metal sheet is made of steel having a thickness in a range from 0.2 mm to 0.3 mm. In some examples, the stiffening portions have a height greater than 0.05 mm and less than 1 mm. The first roller 220 includes first and second sets of male projections 224 corresponding to locations of the stiffening portions of the first and second predetermined patterns. Spaces 226 are located between the first and second sets of male projections 224 that form first and second predetermined patterns 238-1 and 238-2 of stiffening portions 240.

The second roller 222 includes first and second sets of female cavities 228 that correspond to locations of the first and second predetermined sets of male projections 224. Spaces 229 are located between the first and second sets of female cavities 228. The first and second sets of male projections 224 bias the metal sheet into the first and second sets of female cavities 228 to form the stiffening portions 240. After passing through the first roller 220 and the second roller 222, trimming of rolls can be performed at 240 if needed. The metal sheet 214 is cut to length at 244. The process is repeated for other double-walled prismatic battery cell enclosures.

As can be appreciated, the circumference of the first and second roller can be equal to a length of a steel blank for the double-walled prismatic enclosure (or a multiple thereof). The outer surface of the first roller 220 and the second roller 222 can include patterns for N of the double-walled prismatic enclosures, where N is an integer. In FIG. 6A, N=1. The circumference of the first roller 220 and the second roller 222 increases with N.

In FIG. 6B, a double-walled enclosure 300 for a prismatic battery cell is shown. The double-walled enclosure 300 includes sides 320, 322, 324, and 326 of an outer enclosure 330 and sides 340, 342, 344, and 346 of an inner enclosure 350. The metal sheet is folded along fold lines 360 to form the inner enclosure 350. Then the metal sheet is folded along fold lines 370 to form the outer enclosure 330. Additional material 380 can optionally be used to provide a gap between the outer enclosure 330 and the inner enclosure 350.

In FIGS. 7A to 7C, the metal sheet 214 is folded along the fold lines 360 to form the inner enclosure 350. Then, the metal sheet 214 is folded along the fold lines 370 to form the outer enclosure 330. In FIG. 7C, the side 320 is welded at 390.

Referring now to FIGS. 8A and 8B, examples of double-walled prismatic battery cells 400 and 450 are shown, respectively. In FIG. 8A, the double-walled prismatic battery cell 400 includes a lid portion 410 and a bottom portion 414 that encloses first and second openings of an inner enclosure 420 and an outer enclosure 422. The lid portion 410 and the bottom portion 414 can be crimped and/or welded (e.g., laser welded).

In FIG. 8B, the double-walled prismatic battery cell 450 includes a first lid portion 460 and a first bottom portion 464 that encloses first and second openings of an inner enclosure 470. The double-walled prismatic battery cell 450 includes a second lid portion 480 and a second bottom portion 484 that encloses first and second openings of an outer enclosure 486.

The first lid portion 460 may include holes 492 to allow terminals 488 and 490 to pass through the first lid portion 460. A hole 494 on the first lid portion 460 ensures that a vent cap 498 on the second lid portion 480 is in fluid communication with an inner volume of the inner enclosure 470. A hole 496 allows electrolyte to be added to the inner enclosure 470.

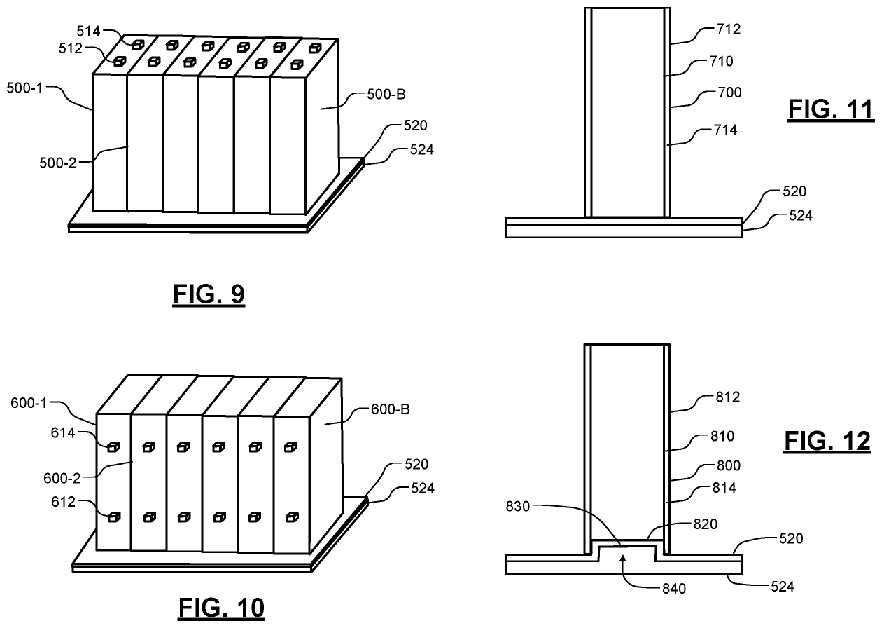

Referring now to FIGS. 9 and 10, examples of cooling plates are shown. In FIG. 9, a plurality of double-walled prismatic battery cells 500-1, 500-2, . . . , and 500-B are arranged on a thermal interface material 520 and a cooling plate 524 to cool bottom surfaces of the plurality of double-walled prismatic battery cells 500-1, 500-2, . . . , and 500-B. The plurality of double-walled prismatic battery cells 500-1, 500-2, . . . , and 500-B include terminals 512 and 514 on top surfaces of the plurality of double-walled prismatic battery cells 500-1, 500-2, . . . , and 500-B opposite to the bottom surfaces.

In FIG. 10, a plurality of double-walled prismatic battery cells 600-1, 600-2, . . . , and 600-B are arranged on the thermal interface material 520 and the cooling plate 524 to cool bottom surfaces of the plurality of double-walled prismatic battery cells 600-1, 600-2, . . . , and 600-B. The plurality of double-walled prismatic battery cells 600-1, 600-2, . . . , and 600-B include terminals 612 and 614 on side surfaces of the plurality of double-walled prismatic battery cells 600-1, 600-2, . . . , and 600-B adjacent to the bottom surfaces.

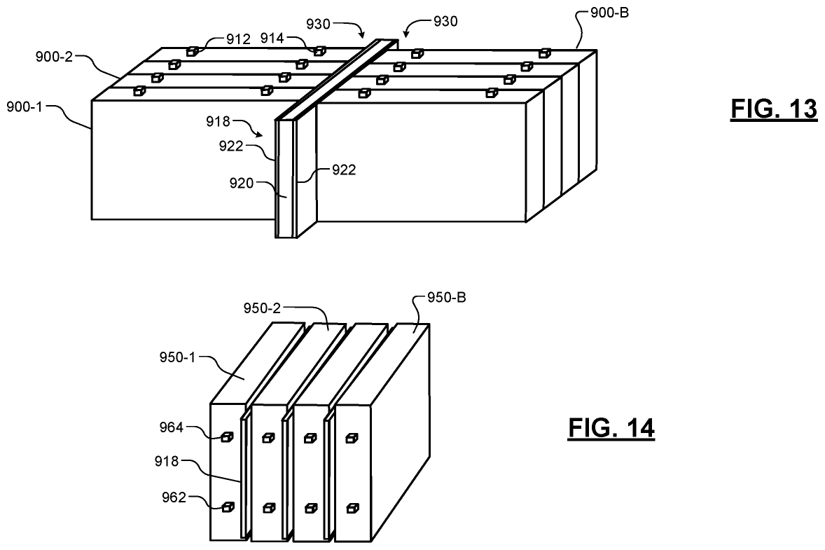

Referring now to FIGS. 11 and 12, examples of an interface between a bottom of the double-walled prismatic battery cell and the thermal interface material 520 and the cooling plate 524 is shown. In FIG. 11, a double-walled prismatic battery cell 700 includes an inner enclosure 710 and an outer enclosure 712. An air gap 714 is formed between the inner enclosure 710 and the outer enclosure 712. When the bottom of the inner enclosure 710 and the outer enclosure 712 is flat, the thermal interface material 520 and the cooling plate 524 can be flat.

In FIG. 12, a double-walled prismatic battery cell 800 includes an inner enclosure 810 and an outer enclosure 812. An air gap 814 is formed between the inner enclosure 810 and the outer enclosure 812. When the bottom of the inner enclosure 810 and the outer enclosure 812 is mechanically joined (double seamed or crimped) and forms a recess at 820, the thermal interface material 520 includes portions 830 that extend into the recesses 820 to maintain thermal communication. The cooling plate 524 includes a projection 840 extending into the portions 830 and/or into the recesses 820.

Referring now to FIGS. 13 and 14, other examples of cooling for a plurality of double-walled prismatic battery cells are shown. In FIG. 13, B double-walled prismatic battery cells 900-1, 900-2, . . . , and 900-B are arranged in an array including a plurality of rows and a plurality of columns. A cooling structure 918 including a cooling plate 920 sandwiched between thermal interface material 922 is arranged between adjacent ends 930 of the double-walled prismatic battery cells 900-1, 900-2, . . . , and 900-B located in adjacent columns. In this example, the terminals are arranged on a top surface of the double-walled prismatic battery cells 900-1, 900-2, . . . , and 900-B. In some examples, thermal interface material is arranged between the inner enclosure and the outer enclosure along a narrow edge of the battery cells.

In FIG. 14, double-walled prismatic battery cells 950-1, 950-2, . . . , and 950-B are arranged adjacent to one another in a single row. The cooling structure 918 (e.g., including the cooling plate 920 sandwiched between thermal interface material 922) is arranged between sides of adjacent ones of the double-walled prismatic battery cells 900-1, 900-2, . . . , and 900-B. In some examples, the stiffening portions are arranged against the thermal interface material 922. In this example, the terminals are arranged on an end surface of the double-walled prismatic battery cells 900-1, 900-2, . . . , and 900-B. In some examples, thermal interface material is arranged between the inner enclosure and the outer enclosure along a wide side of the battery cells.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
a battery cell stack including:
A anode electrodes;
C cathode electrodes; and
S separators, where A, C, and S are integers greater than one; and
a double-walled prismatic enclosure configured to house the battery cell stack including:
a can body including an inner enclosure, an outer enclosure, and a gap between the inner enclosure and the outer enclosure,
wherein the battery cell stack is arranged in the inner enclosure,
wherein the outer enclosure of the can body defines a first opening and a second opening at opposite ends thereof;
a first lid portion attached to the first opening of the outer enclosure; and
a first bottom portion attached to the second opening of the outer enclosure.

2. The battery cell of claim 1, wherein a first side of the outer enclosure includes a plurality of stiffening portions arranged in a first pattern.

3. The battery cell of claim 2, wherein:
a second side of the outer enclosure includes a plurality of stiffening portions arranged in a second pattern, and
the first pattern and the second pattern are different.

4. The battery cell of claim 3, wherein the first pattern and the second pattern are offset to allow nesting of the battery cell with one or more adjacent battery cells.

5. The battery cell of claim 2, wherein the plurality of stiffening portions comprise at least one of dimples and stiffening beads.

6. The battery cell of claim 5, wherein the dimples have one of a rectangular cross section and an arcuate cross section.

7. The battery cell of claim 1, further comprising thermal interface material arranged in the gap between the inner enclosure and the outer enclosure.

8. The battery cell of claim 1, further comprising:
a second lid portion enclosing a third opening of the inner enclosure; and
a second bottom portion enclosing a fourth opening of the inner enclosure.

9. The battery cell of claim 1, wherein at least one of the first lid portion and the first bottom portion includes a vent.

10. A system comprising:
a plurality of the battery cells of claim 1;
a cooling plate;
a thermal interface material arranged between the cooling plate and a first one of the plurality of the battery cells and a second one of the plurality of the battery cells.

11. A method for manufacturing a double-walled prismatic battery cell, comprising:
folding a sheet of metal to form an inner enclosure of the double-walled prismatic battery cell;
folding the sheet of metal to form an outer enclosure of the double-walled prismatic battery cell around the inner enclosure with an air gap arranged between the outer enclosure and the inner enclosure,
wherein the outer enclosure includes a first opening and a second opening;
arranging a battery cell stack in the inner enclosure;
attaching a first lid portion to a first opening of the outer enclosure; and
attaching a first bottom portion to a second opening of the outer enclosure.

12. The method of claim 11, wherein the battery cell stack includes:
A anode electrodes;
C cathode electrodes; and
S separators, where A, C, and S are integers greater than one.

13. The method of claim 11, further comprising using first and second rollers to create a first pattern of stiffening portions on a first side of the outer enclosure and a second pattern of stiffening portions on a second side of the outer enclosure.

14. The method of claim 13, wherein the first pattern of stiffening portions and the second pattern of stiffening portions are different.

15. The method of claim 14, wherein the first pattern of stiffening portions and the second pattern of stiffening portions are offset to allow nesting of the double-walled prismatic battery cell with one or more adjacent double-walled prismatic battery cells.

16. The method of claim 13, wherein the first pattern of stiffening portions comprise dimples having at least one of a rectangular cross section and an arcuate cross section.

17. The method of claim 13, wherein the first pattern of stiffening portions comprise stiffening beads.

18. The method of claim 11, further comprising arranging thermal interface material in the gap.

19. The method of claim 11, further comprising:
prior to attaching the first lid portion, enclosing a third opening of the inner enclosure using a second lid portion; and
prior to attaching the first bottom portion, enclosing a fourth opening of the inner enclosure using a second bottom portion.

20. The method of claim 11, further comprising providing a vent on at least one of the first lid portion and the first bottom portion.
